(19) United States
(12) Patent Application Publication
(10) Pub. No.: US 2019/0280769 A1
(43) Pub. Date: Sep. 12, 2019

(54) LAMP WITH CODED LIGHT FUNCTIONALITY

(71) Applicant: PHILIPS LIGHTING HOLDING B.V., Eindhoven (NL)

(72) Inventor: Stefan Marcus VERBRUGH, Eindhoven (NL)

(73) Assignee: Philips Lighting Holding B.V., Eindhoven (NL)

(21) Appl. No.: 16/319,367

(22) PCT Filed: Jul. 6, 2017
(86) PCT No.: PCT/EP2017/067008

§ 371 Date: Jan. 21, 2019

(30) Foreign Application Priority Data
Jul. 21, 2016 (EP) 16180479.4

(51) Int. Cl. H04B 10/116; H05B 33/08; F21V 23/02

(52) U.S. Cl. CPC H04B 10/116; F21V 23/023; H05B 33/0845

(57) ABSTRACT

A lamp comprises a plurality of luminous segments each at a different position within the lamp, wherein each of the luminous segments is arranged to emit illumination modulated to transmit a different respective code. A controller is configured to control the codes of the different luminous segments so as to have a predefined relationship therebetween (e.g. one code is N and the other is N+1).

### TECHNICAL FIELD

The present disclosure relates to a lighting apparatus having the ability to modulate the illumination it emits in order to embed a signal into the illumination.

### BACKGROUND

Visible light communication (VLC) refers to the communication of information by means of a signal embedded in visible light, sometimes also referred to as coded light (CL). The information is embedded by modulating a property of the visible light, typically the intensity, according to any suitable modulation technique. E.g. according to one example of a coded light scheme, the intensity of the visible light from each of multiple light sources is modulated to form a carrier waveform having a certain modulation frequency, with the modulation frequency being fixed for a given one of the light sources but different for different ones of the light sources such that the modulation frequency acts as a respective identifier (ID) of each light source. In more complex schemes a property of the carrier waveform may be modulated in order to embed symbols of data in the light emitted by a given light source, e.g. by modulating the amplitude, frequency, phase or shape of the carrier waveform in order to represent the symbols of data. In yet further possibilities, a baseband modulation may be used i.e.—there is no carrier wave, but rather symbols are modulated into the light as patterns of variations in the brightness of the emitted light. This may either be done directly (intensity modulation) or indirectly (e.g. by modulating the mark:space ratio of a PWM dimming waveform, or by modulating the pulse position).

The current adoption of LED technology in the field of lighting has brought an increased interest in the use of coded light to embed signals into the illumination emitted by luminaires, e.g. room lighting, thus allowing the illumination from the luminaires to double as a carrier of information. Preferably the modulation is performed at a high enough frequency and low enough modulation depth to be imperceptible to human vision, or at least such that any visible temporal light artefacts (e.g. flicker and/or strobe artefacts) are weak enough to be tolerable to humans.

Based on the modulations, the information in the coded light can be detected using a photodetector. This can be either a dedicated photocell, or a camera comprising an array of photocells (pixels) and a lens for forming an image on the array. E.g. the camera may be a general purpose camera of a mobile user device such as a smartphone or tablet. Camera based detection of coded light is possible with either a global-shutter camera or a rolling-shutter camera (e.g. rolling-shutter readout is typical to mobile CMOS image sensors found in mobile devices such as smartphones and tablets). In a global-shutter camera the entire pixel array (entire frame) is captured at the same time, and hence a global shutter camera captures only one temporal sample of the light from a given luminaire per frame. In a rolling-shutter camera on the other hand, the frame is divided into lines (typically horizontal rows) and the frame is exposed line-by-line in a temporal sequence, each line in the sequence being exposed at a slightly later time than the last. Thus the rolling-shutter readout causes fast temporal light modulations to translate into spatial patterns in the line-readout direction of the sensor, from which the encoded signal can be decoded. Hence while rolling-shutter cameras are generally the cheaper variety and considered inferior for purposes such as photography, for the purpose of detecting coded light they have the advantage of capturing more temporal samples per frame, and therefore a higher sample rate for a given frame rate. Nonetheless coded light detection can be achieved using either a global-shutter or rolling-shutter camera as long as the sample rate is high enough compared to the modulation frequency or data rate (i.e. high enough to detect the modulations that encode the information).

Coded light has many possible applications. For instance a different respective ID can be embedded into the illumination emitted by each of the luminaires in a given environment, e.g. those in a given building, such that each ID is unique at least within the environment in question. E.g. the unique ID may take the form of a unique modulation frequency or unique sequence of symbols. This can then enable any one or more of a variety of applications. For example if a mobile device for remotely controlling the luminaires is equipped with a light sensor such as a camera, then the user can direct the sensor toward a particular luminaire or subgroup of luminaires so that the mobile device can detect the respective ID(s) from the emitted illumination captured by the sensor, and then use the detected ID(s) to identify the corresponding one or more luminaires in order to control them. This provides a user-friendly way for the user to identify which luminaire or luminaires he or she wishes to control. E.g. the mobile device may take the form of a smartphone or tablet running a lighting control app, with the app being configured to detect the embedded IDs from the captured light and then enact the corresponding control functionality (e.g. via a RF back channel).

As another example, there may be provided a location database which maps the ID of each luminaire to its location (e.g. coordinates on a floorplan), and this database may be made available to mobile devices from a server via one or more networks such as the Internet and/or a wireless local area network (WLAN). Then if a mobile device captures an image or images containing the light from one or more of the luminaires, it can detect their IDs and use these to look up their locations in the location database in order to detect the location of the mobile device based thereon. E.g. this may be achieved by measuring a property of the received light such as received signal strength, time of flight and/or angle of arrival, and then applying technique such as triangulation, trilateration, multilateration or fingerprinting; or simply by assuming that the location of the nearest or only captured luminaire is approximately that of the mobile device (and in some cases such information may be combined with information from other sources, e.g. on-board accelerometers, magnetometers or the like, in order to provide a more robust result). The detected location may then be output to the user through the mobile device for the purpose of navigation, e.g. showing the position of the user on a floorplan of the building. Alternatively or additionally, the determined location may be used as a condition for the user to access a location based service. E.g. the ability of the user to use his or her mobile device to control the lighting (or another utility such as heating) in a certain region (e.g. a certain room) may be made conditional on the location of his or her mobile device being detected to be within that same region (e.g. the same room), or perhaps within a certain control zone associated with the lighting in question. Other forms of location-based service may include, e.g., the ability to make or accept location-dependent payments.

As another example, a database may map luminaire IDs to location specific information such as information on a particular museum exhibit in the same room as a respective one or more luminaires, or an advertisement to be provided to mobile devices at a certain location illuminated by a respective one or more luminaires. The mobile device can then detect the ID from the illumination and use this to look up the location specific information in the database, e.g. in order to display this to the user of the mobile device. In further examples, data content other than IDs can be encoded directly into the illumination so that it can be communicated to the receiving device without requiring the receiving device to perform a look-up.

Thus coded light has various commercial applications in the home, office or elsewhere, such as a personalized lighting control, indoor navigation, location based services, etc.

For instance indoor positioning (IPS) based on VLC is currently being introduced in the market, i.e. in retail scenarios such as supermarkets. A unique advantage of VLC (coded light) based indoor positioning over other positioning technologies is the higher accuracy and the availability of accurate and instant orientation information. Orientation information is extremely useful because it can indicate to a user whether something is left or right, and can display the map of a venue with the orientation in line with the real venue. If the user moves, correct orientation of the map can be maintained.

### SUMMARY

Detecting orientation typically requires two different coded light signatures to be within view of the camera (if the positions are also known from the location database then the positions of the two different lights within the image tells the detector which direction the camera is viewing them from). Currently, with one ID per luminaire, this requires two luminaires to be within field of view of the camera. Even if orientation is not an issue (or not the only issue), higher positioning accuracy is not obtained unless two or more codes are in view (e.g. to allow triangulation, trilateration, multilateration, or fingerprinting). Or more generally, there may be other applications where it is desirable to emit more than two codes that can be detected at once, e.g. to provide dual data channels in parallel.

In a multi-lamp fixtures, the adjacent lamps are often elongated in shape and parallel to each other (e.g. as with TLEDs), and hence are close to each other. This is not favorable for coded light detection, because from experience, the inventors have found that the detection software has difficulty detecting different codes from adjacent, parallel, elongated tubes. Also, this is not favorable for positioning because when the codes are close to each other, it is not possible to accurately derive the orientation. Other problems could also be experienced with these or other shaped lamps. For instance it is not always the case that multiple luminaires are in field of view of the detector (e.g. camera). Also, some luminaires only take a single lamp, or else only one of the lamps in the luminaire may be a coded light emitter. Hence there may only be a single coded lamp in view.

Conventionally factors such as the above would mean that often only a single signal can be emitted or detected at any given time. In addition, a coded light lamp is more expensive than a non-coded light lamp, so it may be preferable to have only one coded light lamp in a multi-lamp fixture.

For any of the above reasons or others, it would be desirable to provide for emitting two (or more) different coded light signals from a single lamp. A key performance indicator for coded light detection is the detection time (particularly but not exclusively when exploited for indoor positioning). Because in general the modulation depth is small (in order to avoid visual flicker), coded light detection is easily disturbed by noise, e.g. caused by mains ripple. Both mains ripple from the lamp being detected and from other lamps can be disturbing. Furthermore, interference between the emitted light from different lamps can also cause difficulty in detection. Due to such factors, a typical coded light detector sometimes need to restart several attempts to detect a code before a correct code is received (verified by CRC).

Therefore including two codes in the same lamp poses even more of a challenge in that, with the segments being so close by, the interference between segments is likely to slow down detection.

According to one aspect of the present disclosure there is provided a lighting apparatus comprising: a lamp comprising a mechanical connector for removably connecting the lamp into a luminaire via a complementary connector of the luminaire, and further comprising a plurality of luminous segments each at a different position within the lamp, wherein each of the luminous segments within said lamp is operable to emit illumination modulated to transmit a different respective code; and a controller configured to control the codes of the different luminous segments, wherein said codes have a predefined relationship therebetween for faster detection of said codes; the predefined relationship being a mathematical relationship such that one respective code is a known function of another respective code.

By emitting not just any two codes, but rather codes that are explicitly controlled to have a predetermined relation between them (e.g. one is N and the other is N+1), then by this relationship also being known at the decoder, this advantageously enables faster detection of each of the two codes even when emitted from within the same lamp. As mentioned, interference between closely placed light-emitters makes detection difficult. However, if the decoder has predetermined knowledge about the code (e.g. that it's probably N+1 or N−1), then this speeds up detection because checking whether the code has a certain value is faster than identifying the value if it can be anything.

In embodiments, each of the codes may be a number, and said predefined relationship may be a numerical relationship.

In embodiments, the luminous segments may consist of two segments, a first segment and a second segment), and the relationship may be that the code of the second segment is the code of the first segment plus or minus a predetermined value. Or in embodiments, the luminous segments may consist of more than two segments, and the relationship may be that the codes of the plurality of segments follow a linear sequence relative to one another.

In embodiments, the luminous segments may consist of two segments, a first segment and a second segment, and each of the codes may be represented by a respective waveform modulated into the emitted illumination, wherein the relationship may be that the waveform representing the code of the second segment is the inverse of the waveform representing the code of the first segment.

In embodiments the controller may be operable to control the timing of the codes, and may be configured to control the codes to be transmitted from the different luminous segments at different times such that the codes do not overlap in time.

In embodiments, the controller may be configured to control the illumination from the different luminous segments to be emitted at different times such that the emissions do not overlap in time.

In embodiments, the controller may be configured to control the codes to be transmitted from the different luminous segments with a pause in between, or to control the illumination to be emitted from the different luminous segments with a pause in between.

In embodiments, the luminous segments may be arranged with a non-illumination-emitting region separating the luminous segments.

In embodiments, the lamp may further comprise an outer transparent, translucent or diffusive casing through which said illumination is emitted, and which may form a cavity in which the luminous segments are encased, the plurality of luminous segments being encased together in the same casing.

In embodiments, the mechanical connector may be configured to receive power from a power supply circuit of the luminaire to power the luminous segments in the lamp to emit said illumination, the plurality of luminous segments being arranged to receive said power via the connector.

In embodiments said mechanical connector may be a plug and for plugging into a socket of the luminaire (i.e. said complementary connector being the socket).

In embodiments the controller may be embedded in the lamp.

In embodiments, the lamp may comprise an LED-based lamp, each of said luminous segments comprising one or more LEDs.

In embodiments the lamp may take the form of a retrofittable LED-based lamp retrofittable into a luminaire (100) designed for a fluorescent tube.

According to another aspect disclosed herein there is provided detecting equipment comprising: a camera for capturing an image of a lamp comprising a plurality of luminous segments each at a different position within the lamp, wherein each of the luminous segments within said lamp is operable to emit illumination modulated to transmit a different respective code; and a decoder configured to detect the codes from the image of the lamp captured by the camera, and to perform the detection of the codes based on a predefined relationship between the codes; the predefined relationship being a mathematical relationship such that one respective code is a known function of another respective code.

In embodiments, each of the codes may be a number, and said predefined relationship is a numerical relationship, in which case the decoder is configured to perform the detection of the codes based on said predetermined numerical relationship.

In embodiments the luminous segments consist of two segments, a first segment and a second segment (108b), and the relationship may be that the code of the second segment is the code of the first segment plus or minus a predetermined value; or the luminous segments consist of more than two segments, and the relationship may be that the codes of the plurality of segments follow a linear sequence relative to one another. In such cases the decoder is configured to perform the detection of the codes based on predetermined knowledge that the codes are offset from one another by said predetermined value or linear sequence.

In embodiments the luminous segments consist of two segments, a first segment and a second segment, wherein each of the codes is represented by a respective waveform modulated into the emitted illumination, and wherein the relationship may be that the waveform representing the code of the second segment is the inverse of the waveform representing the code of the first segment. Ion such cases the decoder is configured to perform the detection of the codes based on predetermined knowledge that the second inverse is the inverse of the first.

In embodiments, the codes may be transmitted from the different luminous segments at different times such that the codes do not overlap in time, or the illumination from the different luminous segments may be emitted at different times such that the emissions do not overlap in time. In such cases the decoder may be configured to distinguish between the codes at least in part based on the different transmission or emission times.

In embodiments the codes may be transmitted from the different luminous segments with a pause in between, or the illumination may be emitted from the different luminous segments with a pause in between. In such cases the decoder may be configured to distinguish between the codes at least in part based on the paus between the transmission or emission times.

In embodiments, the luminous segments are arranged with a non-illumination-emitting region separating the luminous segments, and the decoder may be configured to distinguish between the codes at least in part based on non-illumination-emitting region.

In embodiments, the controller is further configured to control the segments to emit respective redundant data based on the respective codes (e.g. CRC data). In embodiments the decoder of the detecting equipment is configured to use the redundant data to verify correct receipt of the respective codes from each of the segments (e.g. to perform a CRC check based on the respective CRC data).

According to another aspect disclosed herein, there is provided a system comprising: the lighting apparatus, connected into the luminaire via the mechanical connector of the lamp and complementary connector of the luminaire; and detecting equipment comprising a camera and a decoder, the decoder being arranged to detect the codes from an image of the lamp captured by the camera, and to perform the detection of the codes based on the predefined relationship between the codes.

According to another aspect disclosed herein, a method comprising: connecting a lamp into a luminaire, wherein the lamp comprises a plurality of luminous segments each at a different position within the lamp, the luminaire providing power in order to power each of the luminous segments; controlling each of the luminous segments within said lamp to emit illumination modulated to transmit a different respective code, wherein said controlling comprises controlling the codes of the different luminous segments so as to have a predefined relationship therebetween for faster detection of said codes; the predefined relationship being a mathematical relationship such that one respective code is a known function of another respective code; using a camera to capture an image of the lamp; and using a decoder to detect the codes from said image, wherein said detection is based on the predefined relationship between the codes of the different luminous segments.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustration of a system comprising a luminaire and a detecting device,

FIG. 2 is a schematic illustration of a lamp connecting into a luminaire,

FIG. 3 is a schematic illustration of a lamp,

FIG. 4 is a schematic illustration of a lamp including two different luminous segments, and

FIGS. 5 to 8 are further schematic illustrations of a lamp with two luminous segments.

### DETAILED DESCRIPTION OF EMBODIMENTS

As mentioned, coded light or “VLC” has a number of applications including for example indoor positioning, such as for the purpose of indoor navigation or the provision of location dependent services or location dependent information (e.g. advertising). For instance such techniques may find an application in retail or office environments, e.g. in stores such as supermarkets (including hypermarkets) or in shopping malls.

However a limitation of VLC based indoor positioning is that, conventionally, high accuracy and orientation can only be reached when the camera of the detecting device (most commonly a smart phone) has at least two luminaires in view. There are a number of undesirable consequences of this. Firstly, the lighting system must be designed so that the distance between the luminaires is small enough for at least two luminaires to always within view of the camera wherever the camera is within the environment of the lighting system. However this may not always be practical. For instance in the case of LED luminaire based indoor positioning in large stores, the inventors have observed that this sometimes needs (undesired) adaptation of the light plan. Another consequence is that if fluorescent lamps are replaced with TLEDs, the light plan is fixed, so if the luminaires are too far apart, indoor positioning is not possible (or has reduced performance). Furthermore, detection of two luminaires may take time, so accurate position and orientation are not always immediately available.

Some luminaires accept more than one fluorescent tube. Accurate positioning and orientation should in principle be possible with two lamps within the same lamp rather than two luminaires, but the full accuracy cannot be not reached if the lamps are parallel and close to each other (as is often the case). In addition, it may be desirable that only one of the lamps in the luminaires is equipped with VLC capability (e.g. for cost reasons).

To address the above consideration or similar, the present disclosure provides techniques for including two different VLC codes within the same lamp, e.g. the same TLED, in a manner that is detectable and distinguishable to the detecting equipment.

For instance, when the lamps are linear in shape (longer than they are wide), such as with replacements for fluorescent tubes, (e.g. TLEDs), then different segments at either end of the linear lamp will allow better detection than two adjacent parallel linear lamps (e.g. dividing the length of the tube into two segments rather than using two parallel tubes). For example when parallel linearly-shaped lamps are close to each other, detecting orientation based on these is not accurate. If the lamps are only partly in view, the center of gravity cannot be determined and hence orientation is even less accurate. Further, detecting the different codes from two parallel linearly-shaped lamps is difficult or even impossible because the light from the two lamps mix. One linearly-shaped lamp with two codes at each end does not have these problems.

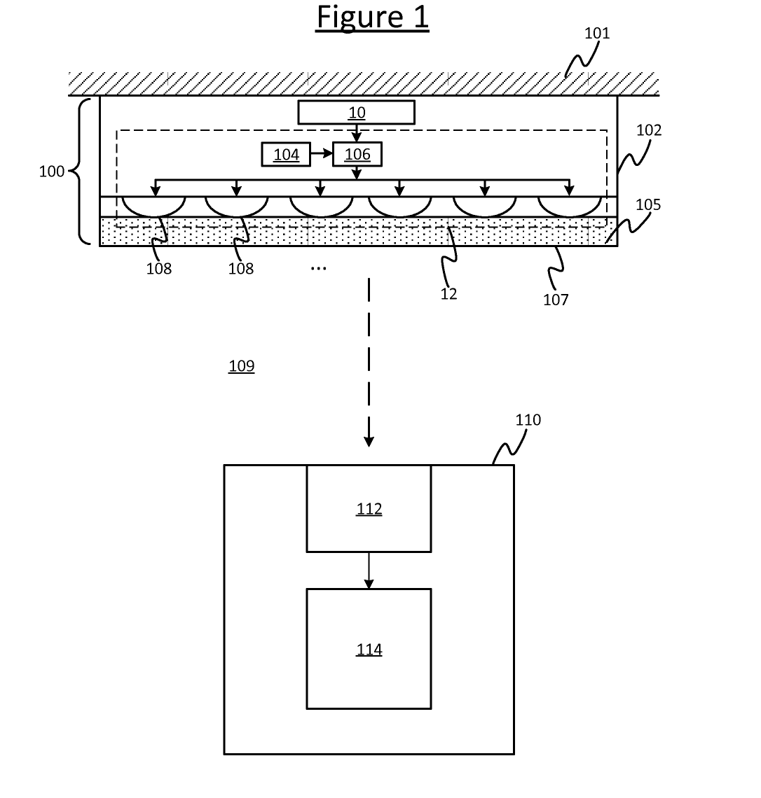

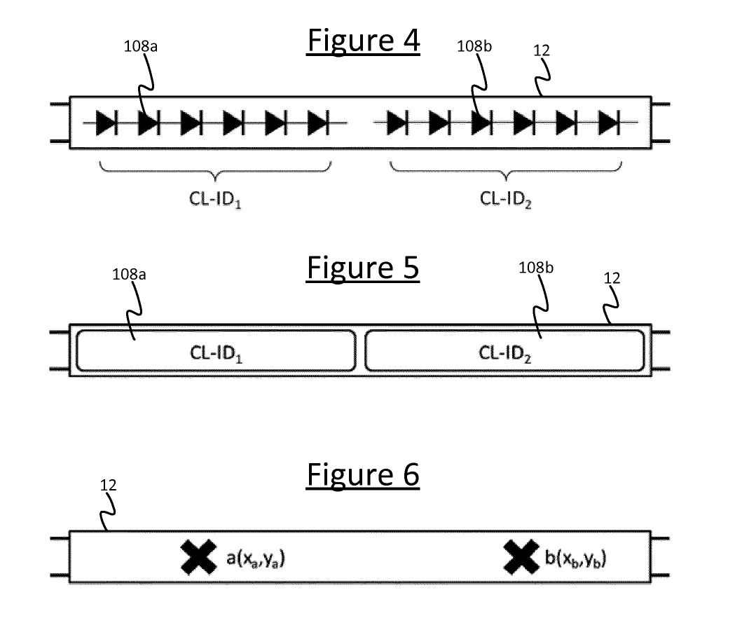

Some example implementation of this will be discussed in more detail shortly with reference to FIGS. 4 to 8, but firstly, for context, an example system in which the disclosed techniques may be applied is described with reference to FIGS. 1 to 3.

FIG. 1 shows an example of a luminaire 100 for emitting coded light and detecting equipment 110 for detecting coded light in accordance with embodiments of the present disclosure. The luminaire 100 is mounted on a supporting surface 101, typically the ceiling (though this could instead be another surface such as a wall, or the luminaire could be suspended). The luminaire 100 may be mounted on the supporting surface 101 by being affixed over the supporting surface 101 (as illustrated) or by being embedded in the surface (a portion of the supporting surface 101 being cut away to accommodate the luminaire 100). Either way, the luminaire 100 is mounted so as to emit visible illumination outward from the supporting surface 101 into an environment 109 in order to contribute to illuminate that environment 109 (so as to enable human occupants to see and find their way about within the environment). The environment 109 in question may be an indoor space such as one or more rooms of an office, home or retail space; or may be an outdoor space such as a park or garden; or a partially covered space such as a stadium or gazebo; or any other occupiable space such as the interior of a train or cruise ship.

The luminaire 100 comprises a luminaire body 102 comprising a housing and connector arranged to accept a lamp 12 via a corresponding connector of the lamp (typically the connector of the luminaire being a socket, i.e. female connector, and the connector of the lamp being a corresponding plug, i.e. male connector). The luminaire is 100 is configured so as via this support to both power the lamp so it can emit its illumination and also physically (i.e. mechanically) support the lamp, i.e. hold it in the luminaire 100. The lamp 12 is thus a removable and replaceable modular component to be plugged into the luminaire 100. Note that the lamp 12 is also a unitary, indivisible component from the perspective of the end-user, i.e. it is not designed to be taken apart by the end-user.

The lamp 100 comprises a plurality of light-emitting elements. The light-emitting elements 108 may be implemented in one or more lamps (with one or more of the light-emitting element 108 per lamp). Each of the light-emitting elements 108 may take any suitable form such as an LED, a set of LEDs, or a filament bulb. Whatever form they take, the light-emitting elements 108 are arranged to actively emit the above-mentioned illumination into the environment 109, being disposed so as when the lamp 12 is connected in the manner for which it is designed, the light emitting elements 108 are arranged to emit light outwards from an outward-facing surface 107 of the luminaire body 102 (a surface facing the environment 109). E.g. the luminaire 105 may comprise a diffuser 105 disposed over the light-emitting elements 108 (between the luminous elements 108 and the environment 109), in which case said surface 107 may be considered the outward facing surface of the diffuser 105 (i.e. the surface facing the environment 109) through which the illumination form the light-emitting elements 108 emit their illumination.

Furthermore, the illumination from the light-emitting elements 108 is modulated to embed a signal in the illumination emitted out into the environment 109, as will be discuses in more detail shortly.

The luminaire 100 further comprises a driver 106 coupled to the light-emitting element 108, and control logic in the form of an embedded controller 104 coupled to the driver 106. The driver 106 is arranged to supply power from a power supply circuit 10 (e.g. a ballast) of the luminaire 100 to the light-emitting elements 108 in order to cause them to actively emit the illumination. That is, the luminaire 100 has or is connected to a power supply (not shown) which supplies energy in a form other than light (typically electricity), and the driver 106 supplies this energy to the light-emitting elements 108 to convert into the illumination which is sent out into the environment 109.

Furthermore, the controller 104 is arranged to control the driver 106 to vary a property of the illumination emitted by the light-emitting elements 108, typically the intensity, in order to thereby modulate the illumination and thereby embed a signal in accordance with coded light techniques which are themselves already known in the art.

The controller 104 may be implemented in the form of software stored in memory of the luminaire 100 and arranged to run on a processor of the luminaire 100 (the memory in which the controller 104 is stored comprising one or more memory units and the processor on which it is arranged to run comprising one or more processing units). Alternatively the controller 104 may be implemented in dedicated hardware circuitry, or configurable or reconfigurable hardware circuitry such as a PGA or FPGA, or any combination of software and hardware.

The detecting equipment 110 comprises a camera 112 and an image processing module 114. The camera 112 is able to capture samples of the modulated illumination at different instances in time. The camera 112 may take the form of a rolling-shutter camera which exposes a given frame line-by-line in a temporal sequence, each line at different moment in time, so as to capture multiple different temporal samples of the modulation in the illumination within a given frame (a given still image). Alternatively the camera 112 may take the form of a global shutter camera which exposes the entire frame at the same time, in which case each frame samples the modulation in the illumination at a different respective time. Note also that even in the case of a rolling-shutter camera, if the message encoded into the signal lasts longer than one frame, then samples from multiple frames may be required. By whatever means the samples are captured, the camera 112 is arranged to output the samples to the image processing module 114 in order for the signal to be decoded from the captured samples, using techniques which are in themselves already known in the art.

The image processing module 114 may be implemented in the form of software stored in memory of the detecting equipment 110 and arranged to run on a processor of the detecting equipment 110 (the memory in which the image processing module 114 is stored comprising one or more memory units and the processor on which it is arranged to run comprising one or more processing units). Alternatively the image processing module 114 may be implemented in dedicated hardware circuitry, or configurable or reconfigurable hardware circuitry such as a PGA or FPGA, or any combination of software and hardware.

The detecting equipment 110 may take the form of a mobile user terminal such as a tablet, smartphone or smartwatch, and the camera 112 may be an integrated camera of the mobile user terminal with the image processing module 114 also being implemented on the same mobile user terminal (e.g. as a suitable light detection “app”). For example the user terminal may be a smartphone or tablet and the camera 112 may be the front-facing camera of the smartphone or tablet. Alternatively the camera 112 may be implemented on a separate physical unit than the image processing module. E.g. the camera 112 may be implemented on a dedicated camera unit or camera peripheral or on a smartphone, tablet or smartwatch, while the image processing module may be implemented on a separate computer unit such as a server, desktop computer or laptop computer, connected to the unit housing the camera 112 via any suitable wired or wireless connection, e.g. a wired connection such as a USB connection, or a wireless connection such as a Wi-Fi or Bluetooth connection, or via a wired or wireless network such as a wireless local area network (e.g. Wi-Fi network) and/or a wired area network or internetwork such as the Internet.

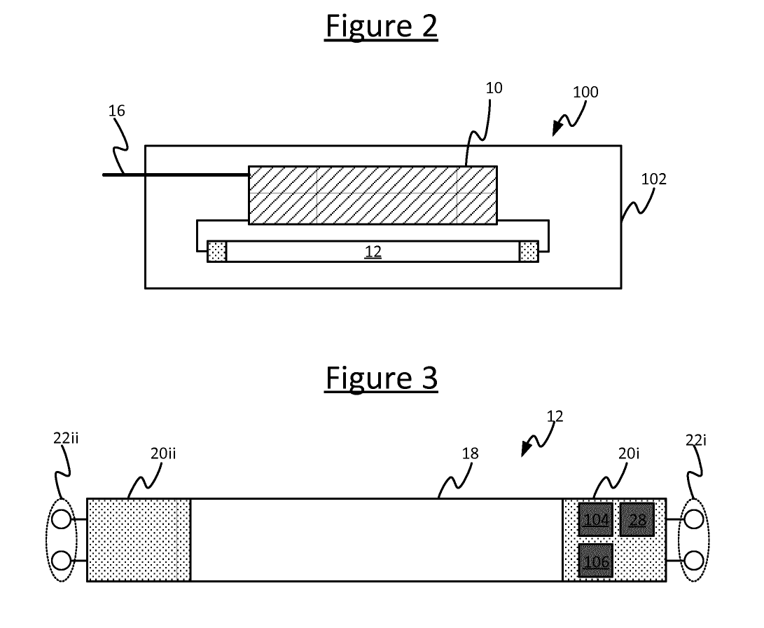

Another illustration of the luminaire 100 and lamp 12 is shown in FIG. 2, here focusing on the connection of the lamp into the luminaire 100 and the supply of power from the luminaire 100 to the lamp. As mentioned, each luminaire 4 comprises a power supply circuit 10, at least one lamp 12, and a housing 102. The power supply circuit 10 may be internal to the housing, and sockets for connecting a plurality of lamps 12 to the power supply circuit 10 in order to power the lamp 12. The housing 102 also comprises a connector in the form of at least one socket into which the lamp 12 fits, in order to supply power to all of the light emitting elements 108 of the lamp 12 via the driver 106 to power them to emit their respective illumination. Thus all the light-emitting elements in the lamp 12 are powered by the same power supply circuit 10 of the same luminaire 100, via a shared connector (e.g. the same plug) connecting to the power supply circuit 10 of that luminaire 100. The power supply circuit 10 may also power the embedded controller 104 (though it is not excluded that this could have a separate power supply such as a battery in the lamp 12). Note that the power supply circuit 10 is not necessarily the ultimate source of the power supplied. Rather, in embodiments the power supply circuit 10 connects to an upstream power supply 16, e.g. the mains supply, and is configured to generate a power supply suitable for powering the lamps 12 based on this. E.g. typically the power supply circuit 10 takes the form of a ballast, i.e. a device for limiting the current supplied to the lamps in its luminaire 4.

In embodiments, the luminaire 100 may take the form of a fluorescent luminaire having sockets for accepting (at least one) of fluorescent tubes (i.e. traditional gas-discharge tube). In this case, the lamp 12 may take the form of a “tube LEDs” (TLED), i.e. a retrofittable LED-based lamp designed to replace the fluorescent tube in a conventional fluorescent luminaire designed for traditional fluorescent tubes. Or in alternative embodiments the lamp 12 may take the form of another type of linearly shaped lamp (having a luminous surface that is substantially longer than it is wide at its widest point, e.g. at least twice as long as it is wide at its widest point, or at least three times as long, or at least five times as long, or at least ten times as long). E.g. in embodiments the lamp 12 may take the form of an LED strip. Some of the following embodiments may be described in terms of the example of a TLED, but it will be appreciated that this is not limiting to all possible embodiments. For example,

[symbol]

FIG. 3 illustrates an individual TLED lamp 12, which may represent any of the lamp 12 used in the luminaire 100 described in relation to FIGS. 1 and 2. As shown, the lamp 12 comprises a casing 18 in which the actual lighting elements (e.g. LEDs) 108 are encased, together in the same optical cavity formed by that casing. The casing 18 typically takes the form of a diffuser to soften the appearance, but it could also be transparent or translucent. Either way the light-emitting elements 108 are arranged so as when powered to emit their illumination through the casing 18. In embodiments the casing 18 may be formed from a single continuous piece of material, e.g. a single piece of plastic.

The lamp 12 also comprises at least one end-cap 20, and in the case of a TLED replacing a fluorescent tube, the lamp 12 in fact comprises two end-caps 20i, 20ii. Each end-cap 20i, 20ii comprises a respective connector 22 for connecting the lamp 12 to the ballast 10 via a socket of the luminaire 100, and thereby connecting the lighting element 18 to the power supplied by the ballast 10. In the case of a fluorescent tube, each connector 22 in fact comprises two terminals (a pair of pins) being either terminal of a receptive filament, though in the case of a TLED replacing a fluorescent tube, the two terminals of each connector are typically shorted together as the need for two terminals is a specific requirement of fluorescent tubes and is not necessarily relevant to LED-based lamps.

Moreover, at least one end-cap 20i of the lamp 12 is used to house additional components, being components specific to the fact that the lamp 12 is a coded-light emitting, wirelessly controlled and/or LED-based replacement for a more traditional lamp such as a fluorescent tube or filament bulb. These additional components the LED driver 106 for converting the power supplied by the ballast 10 (designed for powering a conventional lamp such as a fluorescent tube) into power suitable for driving an LED-based lighting elements 108. The driver is connected via a rectifier (not shown) to the connector(s) 22i, 22ii of the lamp 12, for receiving the AC power supplied by the ballast 10 and converting it to DC and then into an approximately constant (but in embodiments adjustable) current supply for powering the LED-based lighting elements 108 (e.g. LEDs), thereby causing a desired light output to be emitted from the lighting element 18. N.B. if the power supplied by the luminaire's power supply circuit 10 is already DC, the rectifier is not needed, but typically in the scenario of a retrofittable LED-based lamp, the power from the luminaire's own power supply circuit (e.g. ballast) 10 will indeed be AC and therefore need rectifying.

Further, the additional components in the end-cap 20i comprise the embedded controller 104, and optionally a wireless interface 28 for controlling the lamp 12 remotely. As mentioned, the controller 104 may be implemented in software stored in an embedded memory of the lamp 12 and run on an embedded processing device of the lamp 12, or the controller 104 may be implemented in hardware circuitry, or a combination of the two. The wireless interface 28 may for example take the form of a radio receiver or transceiver, such as a ZigBee, Wi-Fi, 802.15.4 or Bluetooth transceiver.

In embodiments, to aid installation for best communication between lamps 12 within a luminaire 4, the end-cap 20i housing the additional components may be marked with a physical (e.g. visible) mark or marks. For instance, a physical mark may be provided at the end where the radio is, and the installer may be instructed to group the marks within a luminaire. Alternatively color coding could be used, with a mark of one color at one end 20i and a mark of another color at the other end 20ii. E.g. a red dot on one cap (and optionally a blue dot on the other cap), and instructions may be provided that caps of the same color go together. This way the lamp 12 is given a predefined, known orientation within the luminaire 100.

Note also that the components 28, 104, 26 do not necessarily have to be housed in the same end-cap 20 nor necessarily in one of the end-caps at all. This is just an illustrative example.

If the optional wireless interface 28 is included, the controller 104 is connected to the wireless interface 28 (as well as the LED driver 106). The controller 104 is configured (e.g. programmed) to use the wireless interface 28 to receive lighting control commands from a manual or automated lighting controller (not shown), such as a dedicated remote control device, a wireless wall switch or wall panel, or a lighting control application running on a user terminal like a smartphone, tablet, laptop computer or desktop computer. In response, the controller 104 then controls the driver 106 in order to control the light output of the lighting elements 108 in accordance with the received control command. For example this may comprise turning the light on or off, dimming the light output up or down, changing the color of the light output, or creating a dynamic (time-varying) lighting effect. E.g. the controller 104 can adjust the current level supplied to the LEDs 108 in order to dim the light output, and/or can adjust the current level supplied to differently colored ones or subarrays of the LEDs 108 in order to adjust the overall color of the light output.

Furthermore, aside from the question of whether or not the lamp 12 allows for wireless dimming or color control, for the present purposes the main function of the controller 104 is to (via the driver 106) control the emission of the illumination so as to modulate a property of the illumination emitted by the light-emitting elements 108, typically intensity (i.e. brightness), and thereby encode a signal into the emitted illumination. In embodiments this signal comprises an ID code which can be used to look up certain information mapped to the ID code in a database accessible to the detecting equipment 110, e.g. the location of the lamp 12.

In fact, according to the present disclosure, the lighting elements 108 are divided into at least two separately-controllable segments 108a, 108b, each comprising one or more of the light-emitting elements 108, and the controller 104 is arranged to control each of the segments 108a, 108b to emit a different respective ID code, CL-ID1 & CL-ID2. An example of this is illustrated in FIG. 4, where the lamp 12 takes a linear form (e.g. a tube such as a TLED) with the light-emitting elements 108 (e.g. LEDs) being arranged in a linear formation, comprising two separate straight lines of LEDs arranged end-to-end with one another along the length of the lamp 12. Thus each of the two codes represents a differ end of the line-shaped lamp 12.

The decoder 114 of the detecting equipment 110 is configured so as, when an image of the lamp is captured by the camera 112, to detect and decode both of the ID codes from the image of the lamp 12. The CL-ID decoder 114 separates the image of the TLED into two parts 108a, 108b and derives the CL-IDs from each part separately. The decoder 114 can then look up both of the codes in a database that maps each of the codes to a respective piece of information. E.g. one or both of the codes may be mapped to a location of the lamp 12 (e.g. known from commissioning), while each of the codes distinguishes between which end of the lamp 12 the code represents. The database could be included locally in the detecting equipment 110 (e.g. stored in local memory if it is a smartphone, tablet or the like), or the decoder 114 may be configured to access the database from a remote entity such as a server (comprising one or more server units at one or more geographical sites) via any wired and/or wireless connection between the detecting equipment 110 and the remote entity. For instance this connection may be via a local wireless connection between the detecting equipment 110 and a wireless access point or router, then a connection via a wired network such the Internet and/or a company intranet. As another example the connection may be via a mobile cellular network. Note also that the term database as used herein does not limit to any specific type of data structure, and the database may take any form from a small look-up table to a large database.

By knowing which ID represents which end of the lamp 12, and by comparing this with the positions of the two segments 108a, 108b in the captured image, the decoder 110 can this detect the orientation of the camera 112 relative to the lamp. Thus it is possible to detect an orientation of the camera 112 (e.g. smartphone camera) based on an image of only a single lamp 12, i.e. with only a single lamp within the field of view of the camera 1124. If both codes also map to the receptive location of the segment 108a, 108, it may also be possible to determine the location of the camera 112 relative to the lamp 12 by measuring a position-dependent property of the received light such as received signal strength, time-of-flight and/or angle-of arrival and applying a localization technique such as triangulation, trilateration, multilateration or fingerprinting. N.B. a triangulation, trilateration or multilateration usually needs three reference points to obtain a unique solution, but when the orientation of the camera 112 is also known as described above (i.e. the decoder 114 knows from which direction the camera 112 is facing the lamp 12), then it is possible to obtain a unique solution to the localization calculation based on only two reference points 108a, 108b.

As shown in FIG. 6, the lamp 12 has two reference points, a(xa,ya) and b(xb,yb)), which are both included in the luminaire location database. Hence one TLED can have the function of two luminaires in an existing VLC indoor positioning systems and can provide accurate positioning and orientation.

Furthermore, to assist detection, the CL-IDs of both sides 108a, 108b of the lamp 12 (e.g. TLED) are linked. For example if the code CL-ID1 on one side 1008a is N, the code CL-ID2 on the other side 108b is N+1, or more generally N plus or minus a predetermined offset, or multiplied by a predetermined factor, or having some other predetermined mathematical relationship between them (one is a known function of the other). An advantaged of using related codes for each half is faster VLC detection by the decoder 114. An exemplary detection process is as follows.

The decoder 114 analyses the image or images captured by the camera 112 to identify one or more “light blobs”, i.e. luminous areas, in the captured image(s). Furthermore, the decoder 114 has predetermined information about the lamps 12, including at least the fact that two-code lamps are installed in the environment 109 in relation to which it is currently being used (or more generally the number of codes per lamp 12). The predetermined information may also include an indication of the shape of the lamps 12 in the environment (e.g. knowing that the lamps are TLEDs implies they are each tube shaped, or knowing the model of TLED may mean the decoder 114 knows its length or relative dimensions). Usually the same type of lamp 12 in the same type of fixture 100 is installed throughout a given environment 109, e.g. a supermarket, or at least only a relatively small number of predetermined types of lamp 12 are present. Thus knowledge of which environment 109 (i.e. venue) the camera 112 capturing images of gives knowledge of the type or types of lamps 12 the decoder 114 is looking for. For instance, the detecting equipment 110 (e.g. smart phone) may have means other than coded light to detect which venue it is in, e.g. through positioning methods that are less accurate but still sufficiently accurate to distinguish different venues (GPS, Core OS location). Alternatively the identity of the venue may be input manually by a user. By whatever means determined, the decoder 114 may then look up the type or types of lamp 12 expected in the identified venue. This could be based on a local database stored locally on the same device as the decoder (e.g. on the smartphone), or the decoder 114 could access a database stored at a remote storage location such as sever (e.g. cloud service), via any suitable wired or wireless connection or network (e.g. any of those discussed previously). Alternatively the decoder 114 could simply be preprogramed to assume a certain type or types of lamp 12.

In embodiments, the decoder 114 may first use the shape of a lamp 12 to aid the detection. For example, in a venue such as a supermarket, there may be light sources with and without coded light. The decoder identifies “light blobs” and tries to derive a coded light ID from each. In order to avoid wasting time on analyzing light blobs that are non-coded light sources, the decoder analyses the shape of the light blobs. Light blobs with other shapes can be ignored (except non coded light TLEDs). Lamps 12 such as TLEDs typically have a clearly defined shape and hence are clearly recognizable to the decoder 114. Further, in embodiments disclosed herein, the decoder 114 splits this shape into two halves and analyses each half to detect the respective code (or more generally splits the shape into the same number of parts as there are codes per lamp 12). The number of codes per lamp 12, and optionally the shape of each segment 108a, 108b, may be known to the decoder as predetermined features given the predetermined type of lamp 12 it is trying to detect, e.g. based on its knowledge of the venue as discussed previously.

Note: in some cases there may be some difficulty in detecting where the transition is between adjacent segments 108a, 108b. There are at least a couple of solutions to this. A first is to provide a dark gap in between the areas with the two codes (though a disadvantage of this is that the gap is visible to people). A second is to program the detector 114 such that it uses the knowledge that the transition between the codes is in the middle of the lamp. Either way, the detector will preferably use areas away from the middle for detection (so avoid trying to detect a code from the blurred area).

Thus the decoder 114 is able to search the captured image(s) for coded light codes. Such coded light detection is faster if the decoder 114 is searching for a particular pre-specified code, rather than trying to detect any arbitrary, unknown signal. This in itself is a property of known coded light decoders that work based on detecting a light source in a captured image or images. Therefore to aid the decoder 114, then according to embodiments of the present disclosure, the different segments 108a, 108b within the lamp 12 are arranged to have different but linked codes. E.g. as mentioned, if the code of a first segment 108a is N then the code of the second segment may be N+1. The decoder 114 is configured to first search the captured image(s) for one of the codes: this may be either an open-ended search for any, unknown arbitrary code (i.e. without any predetermined knowledge of the first code per se, which is slower); or alternatively the decoder 114 may be configured with predetermined knowledge that the codes emitted by the lamp(s) 12 in the environment 109 will be from amongst a predetermined finite set, in which case it can limit the search (this being faster is such predetermined knowledge is available). Either way, the decoder 114 thus first detects the code of one of the luminous segments 108a, 108b in the lamp 12. Then, based on its predetermined knowledge of the relationship between the codes, the decoder 114 is configured to seek the related code in the other, neighboring segment 108b, 108a of the lamp (or other codes in the other segments if there are more than two segments). So for example, if the decoder 114 is configured with the information that the lamp 12 has two coded luminous segments and the codes within the lamp are related by the relationship N and N+1, then once it has found one code in a given lamp 12, it need only attempt to detect the same code +1 or −1 in the neighboring segment (the decoder 114 does not know which it has found—it may have found N+1 so needs to check for N, or it may have found N so it needs to check for N+1). This is faster than performing an open-ended search of the image for any two, arbitrary, unconnected codes.

Note also that in embodiments, the coded light signal from each luminous segment 108a, 108b further comprises redundant information generated based on the emitted code to be detected, e.g. CRC data or a checksum. In this case the decoder 114 may be configured to use the redundant information to verify that each codes has been correctly detected, e.g. by performing a CRC check or checking the checksum.

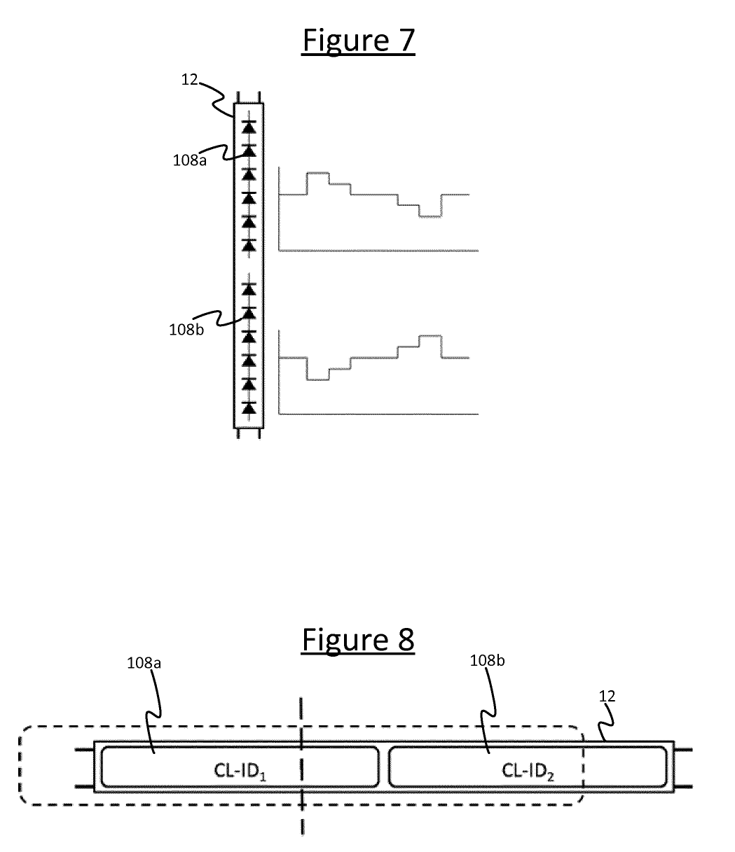

As another example of a linked code is illustrated in FIG. 7. Here, when the current on one side increases, the current on the other side decreases. I.e. the waveform of one of the codes is the inverse of the other. As well as enabling faster detection, this has the additional advantage that the total current is constant over time. In embodiments, this means the driver 106 can be made simpler and cheaper. Because the external drive current for a TLED is constant (being the current from the ballast that was originally intended for a fluorescent lamp), then the only way to make variations in time is to temporarily store electrical energy in a capacitor or coil. Capacitors and coils are expensive and need attention to reach sufficient lifetime. However if the total output current is constant over time as in FIG. 7, no storage of electrical energy is needed.

Furthermore, some methods of creating coded light cause flicker, which can be annoying to the occupants of the environment and/or can interfere with other equipment (e.g. barcode scanners). However with an embodiment as shown in FIG. 7 where one code CL-ID1 is the inverse of the other CL-ID2, the total light output is constant over time, avoiding flicker (in the light that illuminates the environment of the lamp). Only a camera 112 can distinguish the two sections 108a, 108b of the lamp 12.

In further embodiments, the lamp 12 is arranged to have a non-illuminating area which separates the areas with the different CL-IDs (in the case of two segments, in the middle of the lamp 12 between the two luminous sections 108a, 108b, e.g. in the middle of the TLED between the two lines of LEDs), This facilitates identification by the camera 112 and detection SW to derive CL-ID1 and CL-ID2 from the image. That is, the decoder 114 is configured to recognize and separate out the positions of the two (or more) different segments 108a, 108b in the captured image based at least in part upon the non-emitting separation between the segments.

As another alternative or additional technique to assist separability of the codes, the codes of the two segments 108a, 108b are not emitted simultaneously, but one after another at different times, preferably with no overlap between them, and preferably periodically. Advantage: detecting 2 different codes of adjacent light emitting areas is difficult if there is no dark gap between the areas. If the codes are emitted after one another, preferably with a pause in between, then both CL-ID1 and CL-ID2 can be detected.

In some embodiments, the decoder 114 can be further configured to detect orientation in a different manner as a contingency in case two segments 108a, 108b of the lamp 12 are not in view at any given time. If the mounting height and lamp size are known, the decoder 114 can detect from the image whether the full lamp 12 is in view or only a part of the lamp 12 is in view (e.g. see FIG. 8 where dotted line 800 represents the part of the lamp 12 that is within the field of view of the camera 112). If the full lamp 12 is in view, the lamp is divided into two equal parts and the code of each part is detected. If however the full lamp is not in view, as shown in FIG. 8, then the decoder 114 tries to identify a code from each half of the part 800 that is in view. One will yield a code, whilst from the other no code can be obtained. From this information the decoder 114 can derive the lamp identity and orientation. In general VLC indoor positioning software starts with analyzing all ‘light blobs’ the camera 112 has in view and selecting the ones that are expected to have coded light based on their shape, and then it identifies the code of each such blob (this is the time consuming process, so wasting time on non-coded light ‘light blobs’ is avoided as much as possible). If the shape of a TLED (or other coded lamp) 12 and one of the two codes is identified, that's enough for accurate positioning plus orientation, provided that the whole of at least one lamp 12 is in view so that the detector 114 ‘knows’ on which side the non-identified coded light ID is. In other words: the lamp 12 is asymmetric and hence accurate positioning and orientation is possible with one code. I.e. if the detector 114 identifies the code from one half 108a of the lamp 12 and sees that there is another part 108b of the same lamp 12 (recognizable from the light blob), it is clear how the lamp 12 is oriented with respect to the camera 112: in part based on the angle of the light blob, but the light blob has symmetry, so still two possibilities exist; but which of these two orientations is the right one follows from the one coded light ID.

A particularly advantageous application of the present invention lies in venue enablement. Venue enablement is a known process to create a luminaire location database. This is a database of the coded light IDs of all luminaires and their location within a particular venue such as a supermarket (i.e. part of the commissioning process). The database is used by the indoor positioning software in the user's detecting device 110 (e.g. smart phone) to obtain the location and orientation of the device 110. According to embodiments disclosed herein, venue enablement of the two reference points a and b (see FIG. 6) is possible in the same way as with luminaires, but with two points per lamp. This may be more difficult for the person doing the venue enablement. However, the following extensions of the current method and tool can alleviate this, That is, in particularly user-friendly embodiments, the two-code property of the TLED is input into the venue enablement (VE) tool (e.g. via AutoCAD drawing and AutoCAD plugin). For example the VE tool allows the user to indicate the orientation of the lamp 100 in addition to which lamp on the map is being captured. VE is done lamp by lamp, as currently, but the tool requires having at least two TLEDs in view during a few seconds. The VE tool can identify which CL-ID is on which side automatically.

The above described embodiments can be advantageous in a variety of scenarios, but in particular in venues where accurate positioning and orientation are not required throughout the venue, but rather only in certain small areas only. E.g. in a venue such as an airport positioning may be provided throughout the whole venue using an RF based technology such as BLE (Bluetooth Low Energy) or Wi-Fi because lower accuracy may be sufficient in most areas of the venue, but in one or more specific areas, orientation and more accurate positioning may be desired needed, e.g. to direct people to the left or to the right, to distribute people over security counters, and/or for entrance control, etc. In these areas VLC based positioning may be provided using one or more of the techniques disclosed herein. Another example would be a shopping mall, where the coded-light illuminated areas may be used to give directions (e.g. left of right), information about items in a shop window, and/or to organize queuing, etc.

It will be appreciated that the above embodiments have been described by way of example only.

For instance the scope of the disclosure is not limited to only two segments 108a, 108b with two respective codes, and instead further luminous CL-emitting segments may be included each with their own respective code. This will increase the resolution of information made available to the decoder from an image of a single lamp 12 in order to perform a position and/or orientation calculation. Furthermore, the scope of the present disclosure is not limited to a positioning or orientation detection. In other use cases, the two (or more) codes could be used for other purposes, e.g. one maps to a location-based advert while another simultaneously links to a location of the luminaire 100 or another piece of information such as factual information on an exhibit.

Further, while in the above embodiments the two codes are applied by a controller 104 embedded in the lamp 12 itself, in alternative embodiments the controller 104 may be external to the lamp 12. For example, the controller 104 may instead be embedded in the luminaire 100 and arranged to communicate the codes to the two or more respective segments 108a, 108b of the lamp 12 via the mated mechanical connector 22. As another example, the controller 104 may be implemented in an entity external to the luminaire 100, e.g. on a server, or in a building controller, centralized lighting control unit, or lighting bridge. In this case the controller 104 may communicate the codes from the external entity to the respective segments 108a, 108b via any wired and/or wireless connection between the external entity and the luminaire (e.g. via a WLAN, a local Ethernet network, and/or the Internet) and then via the mating of the mechanical connector 22.

Note also therefore that the function of the mechanical connector 22 is not necessarily only to supply power. In embodiments, the connector 22 may also supply a data signal between the luminaire 100 and the lamp 12, such as to supply the codes to be emitted to the luminous segments 108a, 108b, and/or to send other data, e.g. to send a lighting control command from or through the luminaire to the lamp 12 (such as to dim the overall illumination level up or down or change its color), or to send status reports back from the lamp 12 to or through the luminaire 100. This could be achieved by signaling on one of the power connections itself, or by including a separate data pin or pins in the connector 22. In other embodiments, the mechanical connector 22 need not have the function of supplying power to the lamp 12 at all. Instead the lamp 12 may have its own internal power supply such as a battery, and the mechanical connector 22 may only have the function of physically holding the lamp in the luminaire, or only that plus a data connection.

In further embodiments, there are various different possibilities for the implementation of the driver 106 and the modulation. Also the mechanical connector 22 is not necessarily limited to a single connecting element (and similarly for the complementary connector in the luminaire 100). For instance in embodiments described above, the different luminous segments 108a, 108b share the same mechanical connector 22 to the power supply circuit 10 (e.g. ballast) of the luminaire 100. This could mean that both (or all) segments 108a, 108b are powered by power supplied via the same connector element of the connector 22. Alternatively each of the different segments 108a, 108b may be powered via a different power input supplied from the luminaire 100 via a different respective connector element. This also allows the possibility for different driver and modulation arrangements. For example in embodiments the driver 106 does not necessarily have to be embedded in the lamp 12, and/or the modulation does not necessarily have to be applied in the lamp. Instead the driver 106 may be implemented in the luminaire 100, in which case the modulation of the power output by the driver may be applied in the luminaire 100 or in the lamp.

For instance in the case of a T-LED replacement (as exemplified above) the driver 106 would be in the T-LED and the different luminous segments 108a may share the same connector element to connect to the power supplied by the luminaire 100. In this case the driver 106 in the lamp 12, under control of the embedded or external controller 104, generates from this two (or more) separately modulated power outputs to drive the two (or more) separate luminous segments 108a, 108b. But in case of another type of device, say with a driver in the luminaire 100 that performs the modulation, then the driver 106 could also have two (or more) outputs via two (or more) separate mechanical connector elements connecting to the lamp 12; one modulated with ID1 driving the first segment 108a via a first connector element, and the other modulated with ID2 driving the second segment 108b via a second, separate connector element. As another alternative, there could be a driver in the luminaire 100 with two unmodulated outputs and two respective add-on modulator units connected between the driver and the respective luminous segments 108a, 108b.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Lighting apparatus comprising:
a lamp comprising a mechanical connector for removably connecting the lamp into a luminaire via a complementary connector of the luminaire, and further comprising a plurality of luminous segments each at a different position within the lamp, wherein each of the luminous segments within said lamp is operable to emit illumination modulated to transmit a different respective code; and
a controller configured to control the codes of the different luminous segments, wherein said codes have a predefined relationship therebetween for faster detection of said codes in which one respective code is defined explicitly based on the another respective code;
the predefined relationship being a mathematical relationship such that one respective code is a known function of another respective code.

2. The apparatus of claim 1, wherein each of the codes is a number, and said predefined relationship is a numerical relationship.

3. The apparatus of claim 2, wherein:
the luminous segments consist of two segments, a first segment and a second segment, and the relationship is that the code of the second segment is the code of the first segment plus or minus a predetermined value; or
the luminous segments consist of more than two segments, and the relationship is that the codes of the plurality of segments follow a linear sequence relative to one another.

4. The apparatus of claim 1, wherein the luminous segments consist of two segments, a first segment and a second segment, wherein each of the codes is represented by a respective waveform modulated into the emitted illumination, and wherein the relationship is that the waveform representing the code of the second segment is the inverse of the waveform representing the code of the first segment.

5. The apparatus of claim 1, wherein the controller is operable to control the timing of the codes, and is configured to control the codes to be transmitted from the different luminous segments at different times such that the codes do not overlap in time.

6. The apparatus of claim 5, wherein the controller is configured to control the illumination from the different luminous segments to be emitted at different times such that the emissions do not overlap in time.

7. The apparatus of claim 5, wherein the controller is configured to control the codes to be transmitted from the different luminous segments with a pause in between, or to control the illumination to be emitted from the different luminous segments with a pause in between.

8. The apparatus of claim 1, wherein the luminous segments are arranged with a non-illumination-emitting region separating the luminous segments.

9. The apparatus of claim 1, wherein the lamp further comprises an outer transparent, translucent or diffusive casing through which said illumination is emitted, and forming a cavity in which the luminous segments are encased, the plurality of luminous segments being encased together in the same casing.

10. The apparatus claim 1, wherein the mechanical connector is configured to receive power from a power supply circuit of the luminaire to power the luminous segments in the lamp to emit said illumination, the plurality of luminous segments being arranged to receive said power via the connector.

11. The apparatus of claim 1, wherein the controller is embedded in the lamp.

12. The apparatus of claim 1, wherein the lamp comprises an LED-based lamp, each of said luminous segments comprising one or more LEDs, wherein the lamp takes the form of a retrofittable LED-based lamp retrofittable into a luminaire designed for a fluorescent tube.

13. Detecting equipment comprising:
a camera for capturing an image of a lamp comprising a plurality of luminous segments each at a different position within the lamp, wherein each of the luminous segments within said lamp is operable to emit illumination modulated to transmit a different respective code; and
a decoder configured to detect the codes from the image of the lamp captured by the camera, and to perform the detection of the codes based on a predefined relationship between the codes in which one respective code is defined explicitly based on the another respective code;
the predefined relationship being a mathematical relationship such that one respective code is a known function of another respective code.

14. A system comprising:
the lighting apparatus of claim 1, connected into the luminaire via the mechanical connector of the lamp and complementary connector of the luminaire; and
detecting equipment comprising a camera and a decoder, the decoder being arranged to detect the codes from an image of the lamp captured by the camera, and to perform the detection of the codes based on the predefined relationship between the codes in which one respective code is defined explicitly based on the another respective code.

15. A method comprising:
connecting a lamp into a luminaire, wherein the lamp comprises a plurality of luminous segments each at a different position within the lamp, the luminaire providing power in order to power each of the luminous segments;
controlling each of the luminous segments within said lamp to emit illumination modulated to transmit a different respective code, wherein said controlling comprises controlling the codes of the different luminous segments so as to have a predefined relationship therebetween for faster detection of said codes in which one respective code is defined explicitly based on the another respective code; the predefined relationship being a mathematical relationship such that one respective code is a known function of another respective code;
using a camera to capture an image of the lamp; and
using a decoder to detect the codes from said image, wherein said detection is based on the predefined relationship between the codes of the different luminous segments.
